(19) United States
(12) Patent Application Publication
(10) Pub. No.: US 2008/0080550 A1
(43) Pub. Date: Apr. 3, 2008

(54) Plug-and-play reader support for an RF switch

(75) Inventor: Ajay Malik, San Jose, CA (US)

Correspondence Address: INGRASSIA FISHER & LORENZ, P.C., 7150 E. CAMELBACK, STE. 325, SCOTTSDALE, AZ, 85251, US

(73) Assignee: Symbol Technologies, Inc.

(21) Appl. No.: 11/529,984

(22) Filed: Sep. 29, 2006

(51) Int. Cl. H04J 3/22

(52) U.S. Cl. 370/465; 370/389

(57) ABSTRACT

An RF switch as described herein can communicate with different types of data transmitting devices such as RF readers, RFID tags, and other RF devices. The RF switch employs “plug-and-play” reader interface adapter modules, which can be pre-installed in the RF switch or downloaded to the RF switch as needed. Each interface adapter module represents or includes a different data protocol (or suite of protocols) that is compatible with a particular class, category, type, or group of data transmitting device. The use of these interface adapter modules enables the RF switch to be deployed in a protocol-agnostic form that is scalable and upgradeable in the field.

### TECHNICAL FIELD

Embodiments of the present invention relate generally to radio frequency identification (RFID) systems, wireless local area networks (WLANs), and any other network incorporating RF elements or RF devices. More particularly, embodiments of the present invention relate to an RF switch that utilizes loadable data communication interfaces for compatibility with data transmitting devices.

### BACKGROUND

An RF switch generally functions as a centralized control point for wireless and RF compliant devices within a data communication network. RF switches can be utilized in RFID systems, which have achieved wide popularity in a number of applications, as they provide a cost-effective way to track the location of a large number of assets in real time. In large-scale applications such as warehouses, retail spaces, and the like, many RFID tags may exist in the environment. Likewise, multiple RFID readers are typically distributed throughout the space in the form of entryway readers, conveyer-belt readers, mobile readers, and the like, and these multiple components may be linked by network controller switches and other network elements.

Similarly, there has been a dramatic increase in demand for mobile connectivity solutions utilizing various wireless components and WLANs. This generally involves the use of wireless access points that communicate with mobile devices using one or more RF channels (e.g., in accordance with one or more of the IEEE 802.11 standards).

RF data transmitting devices, such as RFID tags and RFID readers, are often manufactured by different vendors, and, therefore, may incorporate incompatible software interfaces and applications. In particular, different vendors may format data using different protocols (for configuring, managing, and monitoring data) that need not be compatible with one another. This poses a problem for a generalized RF switch that is intended to serve as a centralized unit for different RFID readers and RF devices, which may be produced by different vendors.

### BRIEF SUMMARY

An RF switch as described herein is configured to support any number of data protocols, even where such protocols are not compatible with each other. The RF switch may be released with one or more modular and upgradeable data communication interfaces, where each data communication interface is compatible with a specified category or type of data transmitting device (for example, RFID readers manufactured by a particular vendor). One embodiment of the RF switch is also capable of downloading data communication interfaces on an as-needed basis, which enables the RF switch to support new data transmitting devices that utilize new data protocols.

The above and other aspects may be carried out in one embodiment by a method of operating an RF switch for compatibility with a data transmitting device. The method involves: determining a device identifier for the data transmitting device; loading a data communication interface corresponding to the device identifier; and processing data received from the data transmitting device using the data communication interface.

The above and other aspects may be carried out in one embodiment by an RF switch configured for compatibility with a plurality of data transmitting devices. The RF switch includes a processing architecture having processing logic configured to: determine a device identifier for a data transmitting device; load a data communication interface corresponding to the device identifier; and process data received from the data transmitting device using the data communication interface.

The above and other aspects may be carried out in one embodiment by an RF switch configured for compatibility with a plurality of data transmitting devices. The RF switch includes: a network interface configured to communicate data between the RF switch and at least one network application; a reader interface manager coupled to the network interface; and a plurality of reader interface adapter modules configured for loadable operation with the reader interface manager. Each of the reader interface adapter modules is configured to communicate data between the RF switch and a respective category of data transmitting devices.

The above and other aspects may be carried out in one embodiment by an RF switch system that includes a first data transmitting device configured to transmit data formatted in accordance with a first protocol, and an RF switch comprising a reader interface manager and a plurality of reader interface adapter modules configured for loadable operation with the reader interface manager. The reader interface adapter modules include a first reader interface adapter module that is compatible with the first protocol.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual overview diagram of a system configured in accordance with an embodiment of the invention;

FIG. 2 is a schematic representation of an RF switch configured in accordance with an embodiment of the invention;

FIG. 3 is a schematic representation that illustrates functional modules of an RF switch architecture; and

FIG. 4 is a flow chart that illustrates an RF switch operating process.

### DETAILED DESCRIPTION

The following detailed description is merely illustrative in nature and is not intended to limit the embodiments of the invention or the application and uses of such embodiments. Furthermore, there is no intention to be bound by any expressed or implied theory presented in the preceding technical field, background, brief summary or the following detailed description.

Embodiments of the invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with any number of data transmission and data formatting protocols and that the system described herein is merely one example embodiment of the invention.

For the sake of brevity, conventional techniques related to signal processing, data transmission, signaling, network control, the 802.11 family of specifications, wireless networks, RFID systems and specifications, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although the figures may depict example arrangements of elements, additional intervening elements, devices, features, or components may be present in an embodiment of the invention.

Without loss of generality, in the illustrated embodiment, many of the functions usually provided by a traditional access point (e.g., network management, wireless configuration, etc.) and/or traditional RFID readers (e.g., data collection, RFID processing, etc.) are concentrated in a corresponding RF switch. It will be appreciated that embodiments of the invention are not so limited, and that the techniques and technologies described herein may be used in conjunction with traditional access points and RFID readers or any other device that communicates via RF channels.

An RF switch as described herein employs loadable modules that can be downloaded from RFID readers (or other devices) or from a network storage location, and run on the RF switch. This enables the RF switch to be scalable and independent of any particular RF data protocol used by the transmitting devices. In practice, any reader can discover an RF switch in the network and establish connection with it. Alternatively, an RF switch can discover any reader in the network. This discovery procedure is independent of the underlying reader protocol. Once the reader is discovered, the RF switch can load a corresponding data communication interface (e.g., a “plug-and-play” module). Data communication interfaces may also be referred to herein as “reader interface adapter modules” because in certain embodiments a data communication interface is implemented as, or is included in, a reader interface adapter module. The interface module may already be maintained at the RF switch or, alternatively, the interface module may need to be downloaded from the reader or from a network storage element.

Using the loaded interface adapter module, the RF switch is immediately capable of configuring, managing, and monitoring data transmitted by the particular type of reader. Moreover, the RF switch can configure and manage additional reader parameters such as antenna configurations, air protocol parameters, and the like. With this plug-and-play support for readers, multiple readers of different types or categories can be supported, thus making the RF switch scalable and useful for large deployments where equipment from different vendors and manufacturers may be present.

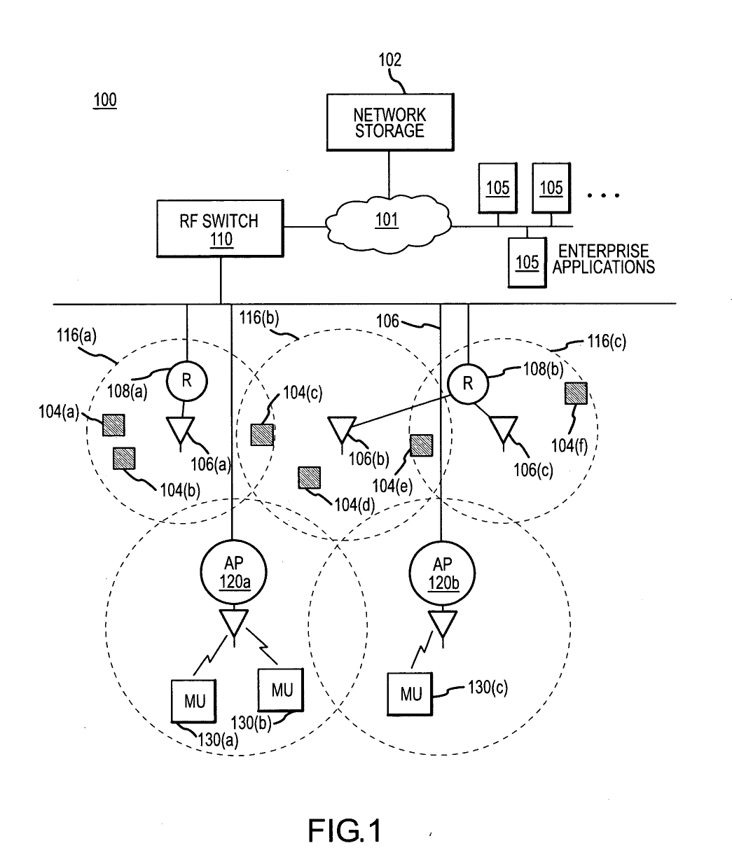

FIG. 1 is a conceptual overview diagram of an RF switch system 100 configured in accordance with an embodiment of the invention. In this system 100, a switching device 110 (alternatively referred to as an “RF switch” or simply “switch”) is coupled to a network 101 that communicates with one or more enterprise applications 105. Network 101 may be, for example, an Ethernet network coupled to one or more other networks or devices. Network 101 may also be coupled to one or more network storage elements, devices, or systems 102 that maintain, manage, and store data in an appropriate amount of memory as needed to support the operations described herein. For this embodiment, system 100 includes a suitably configured network storage element 102 coupled to RF switch 110 via network 101, and network storage element 102 is capable of storing one or more downloadable reader interface adapter modules for RF switch 110.

RF switch 110 is suitably configured to communicate with a number of data transmitting devices using wireless and/or a wired data communication links. As used herein, a “data transmitting device” may be, without limitation: an RFID reader; an RFID tag; an RF reader; an RF device; a wireless computing device such as a laptop computer or a personal digital assistant; an access port; an RFID exciter; a location receiver; or the like. RF switch 110 may receive data from devices via an access point or access port, an RFID reader, etc., but the data may be directed to RF switch 110 with the access point/port or RFID reader serving as a bridging device. A data transmitting device may also receive data from RF switch 110. In other words, RF switch 110 may support unidirectional and bidirectional communication with data transmitting devices. In practical embodiments, different data transmitting devices or different types, categories, or groups of data transmitting devices may utilize different data communication and/or data formatting protocols when transporting data to/from RF switch 110.

One or more wireless access ports 120 (alternatively referred to as “access ports” or “APs”) are configured to wirelessly connect to one or more mobile units (MUs) 130. APs 120 suitably communicate with RF switch 110 via appropriate communication lines (e.g., conventional Ethernet lines, or the like). Any number of additional and/or intervening switches, routers, servers, and other network components may also be present in the system 100.

A number of RFID tags 104 may be distributed throughout the environment. These tags 104 are read by a number of RFID readers (or simply “readers”) 108 having one or more associated antennas 106 provided within the environment. The term “tag” refers, in general, to any RF element that can be communicated with and has an ID that can be read by another component. Readers 108, each of which may be stationary or mobile, are coupled via wired or wireless data links to RF switch 110.

In various embodiments, enterprise applications 105 may be, without limitation: an RFID enterprise application; a database server application (e.g., an application provided by SAP, Oracle, BEA, IBM, or the like). Specific example applications include, without limitation applications for: tagging and shipping to enable supplier compliance and internal transfers; asset management; physical identification or control access for secure identification; inventory management, e.g., automated re-order of spare parts for service depots; track and trace for enterprise-wide asset visibility; returnable assets to improve asset tracking and speed returns processing, etc.

A particular AP 120 may have a number of associated MUs 130. For example, in the illustrated topology, MUs 130(a) and 130(b) are associated with AP 120(a), while MU 130(c) is associated with AP 120(b). One or more APs 120 may be coupled to a single RF switch 110, as illustrated.

RF Switch 110 determines the destination of packets it receives over network 101 and routes those packets to the appropriate AP 120 if the destination is an MU 130 with which that AP 120 is associated. Each RF switch 110 therefore maintains a routing list of MUs 130 and their associated APs 120. These lists are generated using a suitable packet handling process as is known in the art. Thus, each AP 120 acts primarily as a conduit, sending/receiving RF transmissions via MUs 130, and sending/receiving packets via a network protocol with RF switch 110. Each AP 120 is typically capable of communicating with one or more MUs 130 through multiple RF channels. This distribution of channels varies greatly by device, as well as country of operation. For example, in accordance with an 802.11(b) deployment there are fourteen overlapping, staggered channels, each centered 5 MHz apart in the RF band.

A particular RFID reader 108 may have multiple associated antennas 106. For example, as shown in FIG. 1, reader 108(a) is coupled to one antenna 106(a), and reader 108(b) is coupled to two antennas 106(b) and 106(c). A reader 108 may incorporate additional functionality, such as filtering, cyclic-redundancy checks (CRC), and tag writing, as is known in the art.

In general, RFID tags 104 (sometimes referred to as “transponders”) may be classified as either active or passive. Active tags are devices that incorporate some form of power source (e.g., batteries, capacitors, or the like), while passive tags are tags that are energized via an RF energy source received from a nearby antenna. While active tags are more powerful, and exhibit a greater range than passive tags, they also have a shorter lifetime and are significantly more expensive. Such tags are well known in the art, and need not be described in detail herein.

Each antenna 106 has an associated RF range (or “read point”) 116, which depends upon, among other things, the strength of the respective antenna 106. The read point 116 corresponds to the area around the antenna in which a tag 104 may be read by that antenna, and may be defined by a variety of shapes, depending upon the nature of the antenna (i.e., the RF range need not be circular or spherical as illustrated in FIG. 1).

It is not uncommon for the RF ranges or read points to overlap in real-world applications (e.g., doorways, small rooms, etc.). Thus, as shown in FIG. 1, read point 116(a) overlaps with read point 116(b), which itself overlaps with read point 116(c). Accordingly, it is possible for a tag to exist within the range of two or more readers simultaneously. For example, tag 104(c) falls within read points 116(a) and 116(b), and tag 104(f) falls within read points 116(b) and 116(c). Because of this, two readers (108(a) and 108(b)) may sense the presence of (or other event associated with) tag 104(c).

As described in further detail below, RF switch 110 includes hardware, software, and/or firmware capable of carrying out the functions described herein. Thus, RF switch 110 may comprise one or more processors accompanied by storage units, displays, input/output devices, an operating system, database management software, networking software, and the like. Such systems are well known in the art, and need not be described in detail here. RF switch 110 may be configured as a general purpose computer, a network switch, or any other such network host.

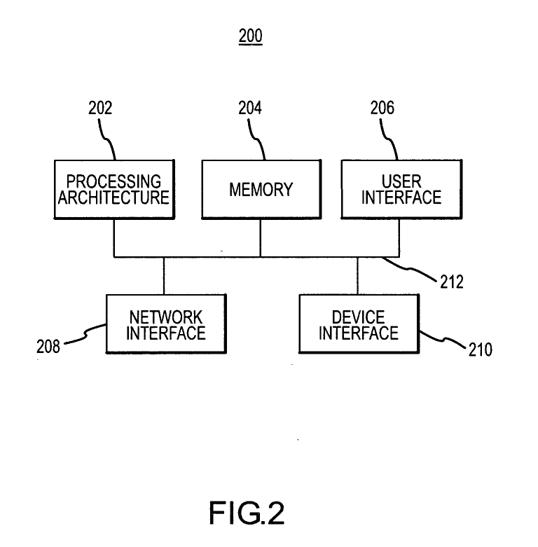

FIG. 2 is a schematic representation of an RF switch 200 configured in accordance with an embodiment of the invention. RF switch 200 may be used, for example, in RF switch system 100. RF switch 200 generally includes a processing architecture 202 having suitably configured processing logic, an appropriate amount of memory 204, a user interface 206, a network interface architecture 208, and a device interface architecture 210. These and other elements of RF switch 200 may be interconnected together using a bus 212 or any suitable interconnection arrangement. Such interconnection facilitates communication between the various elements of RF switch 200. A working embodiment of RF switch 200 may also include components and elements configured to support known or conventional operating features that need not be described in detail herein.

Processing architecture 202 can include any number of physical components or elements. In this regard, processing architecture 202 may be implemented or realized with a general purpose processor, a content addressable memory, a digital signal processor, an application specific integrated circuit, a field programmable gate array, any suitable programmable logic, device, discrete gate or transistor logic, discrete hardware components, or any combination thereof, designed to perform the functions described herein. A processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Processing architecture 202 is primarily responsible for the general operation of RF switch 200, e.g., switching, data communication, and data packet processing. In addition, processing architecture 202 performs a number of operations related to the handling of plug-and-play data communication interfaces as described in more detail below. Thus, processing architecture 202 represents or includes suitably configured processing logic that carries out the functions, techniques, and processing tasks associated with the operation of RF switch 200.

Memory 204 may be implemented or realized with RAM memory, flash memory, ROM memory, EPROM memory, EEPROM memory, registers, a hard disk, a removable disk, a CD-ROM, or any other form of storage medium known in the art. Memory 204 can be coupled to processing architecture 202 such that processing architecture 202 can read information from, and write information to, memory 204. In the alternative, memory 204 may be integral to processing architecture 202. As an example, processing architecture 202 and memory 204 may reside in a suitably configured ASIC.

Memory 204 includes sufficient data storage capacity to support the operation of RF switch 200. In certain embodiments of RF switch 200, memory 204 is configured to store a plurality of available data communication interfaces (preferably in a modular format) corresponding to different data transmitting devices. A given interface module may be stored in memory 204 during the manufacturing of RF switch 200, stored in memory 204 at any time before deployment of RF switch 200, or stored in memory 204 after deployment of RF switch 200. In certain embodiments of RF switch 200, interface modules can be downloaded into memory 204 on an as-needed basis while RF switch 200 is operating within its system environment.

User interface 206 may include one or more features that enable direct user interaction with RF switch 200. For example, user interface 206 may include a keypad, keys, buttons, switches, lights, a display element, knobs, a touchpad, a joystick, a pointing device, a virtual writing tablet, or any device, component, or function that enables a user to select options, input information, or otherwise control the operation of RF switch 200.

Network interface architecture 208 represents hardware, software, firmware, and/or processing logic that is configured to communicate data (and process that data) between RF switch 200 and one or more network devices, systems, or applications (e.g., enterprise applications 105 shown in FIG. 1). For this example, network interface architecture 208, possibly cooperating with other elements of RF switch 200, reformats data received from data transmitting devices for compatibility with the enterprise applications. Moreover, network interface architecture 208 may be suitably configured to handle the downloading of reader interface adapter modules from a storage element on an as-needed basis. In practice, network interface architecture 208 can be configured to support any number of wired and/or wireless data transport schemes and any number of data communication/formatting protocols for compliance with the intended enterprise applications.

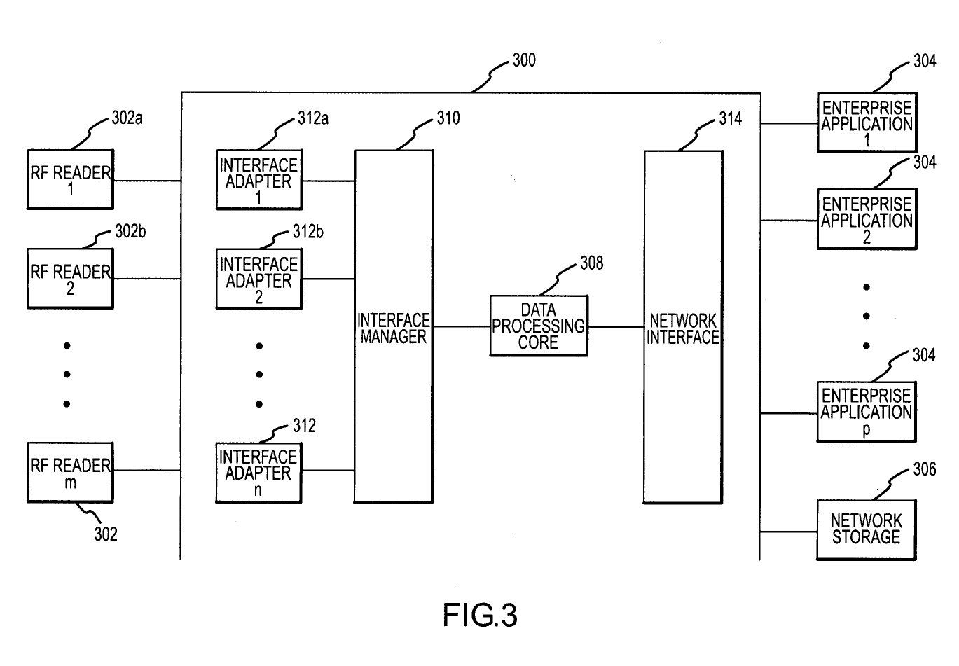

Device interface architecture 210 represents hardware, software, firmware, and/or processing logic that is configured to communicate data (and process that data) between RF switch 200 and one or more data transmitting devices in the manner described herein. In particular, device interface architecture 210 may include or operate with a plurality of reader interface adapter modules and a reader interface manager (see FIG. 3), where the modules and the interface manager enable RF switch 200 to operate in a scalable and protocol-agnostic manner. In practice, device interface architecture 210 can be configured to support any number of wired and/or wireless data transport schemes and any number of data communication/formatting protocols for compliance with different data transmitting devices.

As mentioned above, network interface architecture 208 and device interface architecture 210 may be suitably configured for compatible data communication with different devices, systems, and applications. For data transport over a cable, a wired connection, or other tangible link, network interface architecture 208 and device interface architecture 210 may support one or more wired/cabled data communication protocols. RF switch 200 can support any number of suitable data communication protocols, techniques, or methodologies, including, without limitation: Ethernet; home network communication protocols; USB; IEEE 1394 (Firewire); hospital network communication protocols; and proprietary data communication protocols.

For wireless data transport, network interface architecture 208 and device interface architecture 210 may support one or more wireless data communication protocols. RF switch 200 can support any number of suitable wireless data communication protocols, techniques, or methodologies, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB.

FIG. 3 is a schematic representation that illustrates functional modules of an RF switch 300 configured in accordance with one embodiment of the invention. FIG. 3 depicts an architecture that might be utilized by RF switch 200 or RF switch 110. For clarity and to avoid redundant descriptions, FIG. 3 does not depict all of the elements shown in FIG. 2. In this example, RF switch 300 can communicate with any number of data transmitting devices (such as RF readers 302) and with any number of enterprise applications 304. RF switch 300 may also be coupled to an appropriate amount of network storage 306, which can be implemented with any number of physical components. FIG. 3 illustrates a generalized embodiment that supports m different RF readers 302 and p different enterprise applications 304, where m and p need not be correlated.

For this embodiment, RF switch 300 includes a data processing core 308, a reader interface manager 310, a plurality of reader interface adapter modules 312, and a network interface architecture 314. A working embodiment of RF switch 300 may also include components and elements configured to support known or conventional operating features that need not be described in detail herein.

Reader interface adapter modules 312 are suitably configured for loadable operation with reader interface manager 310. FIG. 3 illustrates a generalized embodiment that supports n different reader interface adapter modules 312, where m, n, and p need not be correlated. Conceptually, each reader interface adapter module 312 functions as a plug-and-play module for RF switch 300. Moreover, each reader interface adapter module 312 is configured to communicate data between RF switch 300 and a respective category, group, or type of data transmitting devices. In this regard, each reader interface adapter module 312 represents or includes one or more data communication/formatting protocols that enable it to process data received by the respective RF readers. Reader interface adapter modules 312 provide an abstract view of the data transmitting devices such that enterprise applications 304 need not be aware of the transmitting device type or the data protocols utilized by the data transmitting devices. Reader interface adapter modules 312 enable RF switch 300 to intermingle different types of RF readers 302 (including different brands, RFID tag types, etc.) to best suit the particular system or application requirements. For example, reader interface adapter modules 312 allow RF switch 300 to be compatible with any number of existing RF data protocols (including passive tag format, semi-passive tag format, 802.11 tag format). Notably, the modular nature of reader interface adapter modules 312 also enables RF switch 300 to be easily upgraded to support newly developed RF data protocols, assuming that appropriate reader interface adapter modules 312 can be written for the new protocols.

As a simple example, reader interface adapter module 312a may be compatible with RF reader 302a (and other RF readers of the same type), while reader interface adapter module 312b may be compatible with RF reader 302b (and other RF readers of the same type). Thus, reader interface adapter module 312a and RF reader 302a are both configured for compatible operation using a first protocol (or a first suite of protocols), while reader interface adapter module 312b and RF reader 302b are both configured for compatible operation using a second protocol (or a second suite of protocols).

Reader interface manager 310 performs various operations associated with the management, control, configuration, and handling of reader interface adapter modules 312. For example, reader interface manager 310 may be configured to perform or manage the following operations, without limitation: (1) storing of reader interface adapter modules 312 in the internal or local memory of RF switch 300; (3) searching available reader interface adapter modules 312 to determine whether RF switch 300 supports a given RF reader 302; (4) selecting a reader interface adapter module 312 to serve as a designated adapter module for a given communication session; (4) loading of available reader interface adapter modules 312 for active use; and (5) downloading of additional reader interface adapter modules from network storage 306, from RF readers 302, or from elsewhere in the system environment.

For this example, reader interface adapter modules 312 provide received data to reader interface manager 310, which in turn feeds data processing core 308, which in turn feeds network interface architecture 314, which in turn communicates with enterprise applications 304. The reverse data processing path can be followed for data being transported from enterprise applications 304 to RF readers 302. Data processing core 308 generally functions to process and format data as it passes through RF switch 300; accordingly, data processing core 308 is depicted as being coupled between reader interface manager 310 and network interface architecture 314. Data processing core 308 may perform virtualization operations to normalize different types of RFID tag data obtained from RF readers 302 for use with the various enterprise applications 304. In this regard, data processing core 308 can receive data packets, reformat the data conveyed in the received data packets, and transmit the reformatted data in an appropriate format or mechanism.

Network interface architecture 314 (possibly cooperating with data processing core 308 and/or reader interface manager 310) may be configured to reformat data received from RF readers 302 as necessary for compatibility with at least one enterprise application 304. Network interface architecture 314 may also be configured to format or normalize data in the reverse direction for processing by RF switch 300. In certain embodiments of RF switch 300, network interface architecture 314 is suitably configured to download reader interface adapter modules from network storage 306 on an as-needed basis (described in more detail below). Such downloading may occur dynamically in response to the discovery of an unsupported RF reader 302, in connection with the upgrading of RF switch 300, or in connection with the initial configuration or setup of RF switch 300.

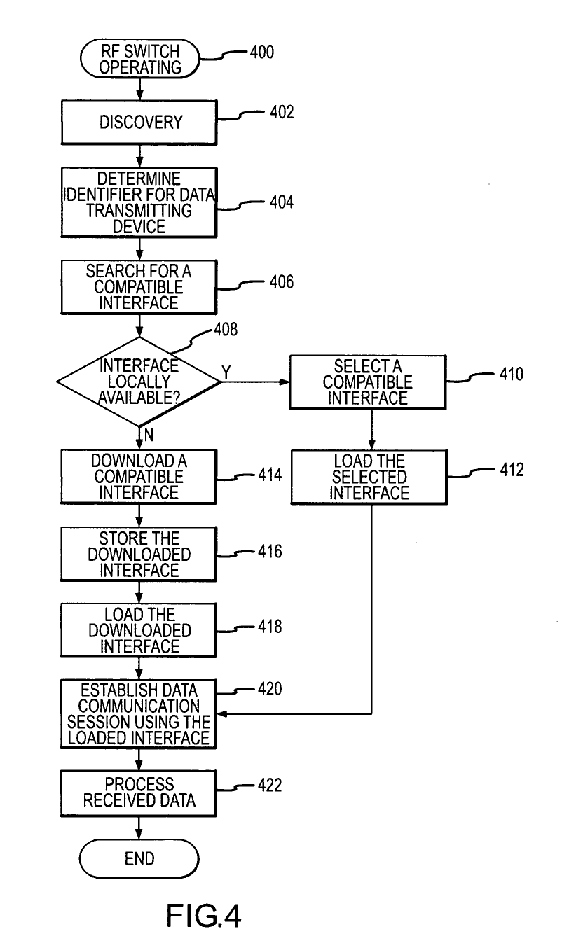

FIG. 4 is a flow chart that illustrates an RF switch operating process 400 suitable for use with any of the RF switches described herein. The various tasks performed in connection with process 400 may be performed by software, hardware, firmware, or any combination thereof. For illustrative purposes, the following description of process 400 may refer to elements mentioned above in connection with FIGS. 1-3. In embodiments of the invention, portions of process 400 may be performed by different elements of the RF switch. It should be appreciated that process 400 may include any number of additional or alternative tasks, the tasks shown in FIG. 4 need not be performed in the illustrated order, and process 400 may be incorporated into a more comprehensive procedure or process having additional functionality not described in detail herein.

Process 400 may be executed when the RF switch attempts to establish a data communication session with a data transmitting device. Accordingly, process 400 may begin with a suitable discovery procedure 402 between the RF switch and the data transmitting device. This discovery procedure 402 may leverage known techniques that enable the RF switch to identify data transmitting devices in its range. In this example, discovery procedure 402 employs a suitable IP data communication protocol that allows the RF switch to obtain or determine a device identifier for the data transmitting device (task 404). As used herein, a “device identifier” represents any information that distinguishes different data transmitting devices. In example embodiments, device identifiers may uniquely identify different device categories, types, groups, serial numbers, manufacturers, brands, or the like. Moreover, each device identifier can be linked to a corresponding data protocol (or suite of protocols).

During task 402 and/or task 404, the RF switch may interrogate a DHCP server to obtain the identities of all data transmitting devices registered with the DHCP server. Alternatively, the RF switch may communicate with the data transmitting device itself using a specified protocol (e.g., IP). Using this alternate methodology the data transmitting device can provide its device identifier to the RF switch. Notably, discovery procedure 402 can operate in the “background” even if the RF switch does not currently support the data communication/formatting protocol utilized by the data transmitting device (which occurs when the RF switch does not have a compatible reader interface adapter module).

After completion of discovery procedure 402, the RF switch will merely be aware of the data transmitting device. In this example, process 400 proceeds such that the RF switch can determine whether or not it has a compatible reader interface adapter module for that data transmitting device. In certain embodiments, the RF switch processes the device identifier corresponding to the data transmitting device to check whether there is a match for the associated device type, group, category, serial number, etc. Accordingly, the RF switch may be searched (task 406) for a compatible data communication interface module that is linked to the device identifier. If a compatible interface module is found (query task 408), then process 400 selects that interface module (task 410) and designates it for use during communications with the data transmitting device. Thus, the device identifier governs the manner in which the RF switch selects the designated reader interface adapter module from a plurality of available modules stored at the RF switch. Thereafter, the RF switch loads the selected interface module (task 412) and readies it for data processing. Referring to FIG. 3, task 412 loads the selected interface module and establishes any necessary hooks between the selected interface module and reader interface manager 310. Following task 412, process 400 may proceed to a task 420 (described below).

If query task 408 determines that the RF switch does not currently support a compatible interface module, then process 400 may attempt to download a compatible interface module (task 414) from a source that is external to the RF switch. The RF switch can use one or more different downloading techniques, depending upon the system implementation, the operating environment, and the present operating conditions. For example, the RF switch may be configured to download a compatible interface module from the data transmitting device itself. This type of downloading may be carried out using a background data protocol, such as the protocol used during discovery procedure 402. As another example, the RF switch may be configured to download a compatible interface module from a storage element coupled to the RF switch. This storage element may be a local memory device or it may be a network storage device that is coupled to the RF switch via a network architecture. Referring to FIG. 3, remotely stored interface modules can be downloaded from network storage 306 to RF switch 300 via network interface architecture 314. In one embodiment, the RF switch may include a pointer or a URL that directs process 400 to an appropriate website or network server that manages the downloading of interface modules.

Thereafter, the RF switch may store the downloaded interface module (task 416) in its local memory as an update. Consequently, the downloaded interface module will be a locally available module the next time the RF switch searches for it. In addition, the RF switch loads the downloaded interface module (task 418) and readies it for data processing. Referring to FIG. 3, task 418 loads the downloaded interface module and establishes any necessary hooks between the downloaded interface module and reader interface manager 310.

Following task 418, the RF switch can establish a data communication session with the data transmitting device using the loaded interface module (task 420). In practice, the data communication session will employ the data communication protocols and/or the data formatting protocols associated with the loaded interface module. The loaded interface module may also be used to process data received from the data transmitting device (task 422). Task 422 may include any appropriate data processing, including the various operations described herein. This data processing may continue until the RF switch terminates the current data communication session.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention, where the scope of the invention is defined by the claims, which includes known equivalents and foreseeable equivalents at the time of filing this patent application.

What is claimed is:

1. A method of operating an RF switch for compatibility with a data transmitting device, the method comprising:
determining a device identifier for the data transmitting device;
loading a data communication interface corresponding to the device identifier; and
processing data received from the data transmitting device using the data communication interface.

2. A method according to claim 1, further comprising selecting the data communication interface from a plurality of available data communication interfaces, wherein the selecting step is governed by the device identifier.

3. A method according to claim 2, further comprising storing the plurality of available data communication interfaces at the RF switch.

4. A method according to claim 1, further comprising:
prior to the loading step, searching the RF switch for the data communication interface; and
if the searching step determines that the RF switch does not support the data communication interface, downloading the data communication interface to the RF switch.

5. A method according to claim 4, wherein the downloading step downloads the data communication interface from the data transmitting device.

6. A method according to claim 4, wherein the downloading step downloads the data communication interface from a storage element coupled to the RF switch.

7. A method according to claim 6, wherein the downloading step downloads the data communication interface from the storage element via a network architecture.

8. A method according to claim 4, further comprising storing the data communication interface at the RF switch, the storing step occurring after the downloading step.

9. A method according to claim 1, wherein determining the device identifier is performed during a discovery procedure between the data transmitting device and the RF switch.

10. An RF switch configured for compatibility with a plurality of data transmitting devices, the RF switch comprising a processing architecture having processing logic configured to:
determine a device identifier for a data transmitting device;
load a data communication interface corresponding to the device identifier; and
process data received from the data transmitting device using the data communication interface.

11. An RF switch according to claim 10, further comprising a memory element coupled to the processing architecture, the memory element being configured to store a plurality of available data communication interfaces, wherein the processing logic is configured to select the data communication interface from the plurality of available data communication interfaces.

12. An RF switch according to claim 10, wherein the processing logic is configured to:
prior to loading the data communication interface, search the RF switch for the data communication interface; and
if the RF switch does not support the data communication interface, initiate downloading of the data communication interface to the RF switch.

13. An RF switch according to claim 10, wherein the processing logic is configured to determine the device identifier during a discovery procedure between the data transmitting device and the RF switch.

14. An RF switch configured for compatibility with a plurality of data transmitting devices, the RF switch comprising:
a network interface configured to communicate data between the RF switch and at least one network application;
a reader interface manager coupled to the network interface; and
a plurality of reader interface adapter modules configured for loadable operation with the reader interface manager, each of the reader interface adapter modules being configured to communicate data between the RF switch and a respective category of data transmitting devices.

15. An RF switch according to claim 14, further comprising a processing architecture coupled to the reader interface manager, the processing architecture comprising processing logic configured to:
select one of the reader interface adapter modules as a designated adapter module for a data transmitting device; and
load the designated adapter module for operation with the reader interface manager.

16. An RF switch according to claim 15, wherein the designated adapter module is configured to process data received from the data transmitting device.

17. An RF switch according to claim 16, wherein the network interface is configured to reformat the data received from the data transmitting device for compatibility with the at least one network application.

18. An RF switch according to claim 14, wherein the network interface is configured to download additional reader interface adapter modules from a storage element on an as-needed basis.

19. An RF switch according to claim 14, further comprising a memory element coupled to the reader interface manager, the memory element being configured to store the plurality of reader interface adapter modules.

20. An RF switch system comprising:
a first data transmitting device configured to transmit data formatted in accordance with a first protocol; and
an RF switch comprising a reader interface manager and a plurality of reader interface adapter modules configured for loadable operation with the reader interface manager, the plurality of reader interface adapter modules including a first reader interface adapter module that is compatible with the first protocol.

21. An RF switch system according to claim 20, wherein each of the reader interface adapter modules is configured to communicate data between the RF switch and a respective category of data transmitting devices.

22. An RF switch system according to claim 20, further comprising a second data transmitting device configured to transmit data formatted in accordance with a second protocol, wherein the plurality of reader interface adapter modules includes a second reader interface adapter module that is compatible with the second protocol.

23. An RF switch system according to claim 20, wherein the RF switch is configured to download the first reader interface adapter module from the first data transmitting device.

24. An RF switch system according to claim 23, wherein the RF switch is configured to download the first reader interface adapter module in accordance with a protocol that is different than the first protocol.

25. An RF switch system according to claim 20, further comprising a storage element coupled to the RF switch, wherein:
the storage element is configured to store at least the first reader interface adapter module; and
the RF switch is configured to download the first reader interface adapter module from the storage element.

26. An RF switch system according to claim 25, wherein the RF switch is configured to download the first reader interface adapter module in accordance with a protocol that is different than the first protocol.

27. An RF switch system according to claim 25, wherein the RF switch is configured to download the first reader interface adapter module from the storage element via a network architecture.

28. An RF switch system according to claim 25, wherein the RF switch is configured to download additional reader interface adapter modules from the storage element on an as-needed basis.
